(19) United States
(12) Patent Application Publication
(10) Pub. No.: US 2024/0179581 A1
(43) Pub. Date: May 30, 2024

(54) A METHOD AND APPARATUS FOR PROVIDING MULTICAST BROADCAST SERVICES IN A TELECOMMUNICATION NETWORK

(71) Applicant: Samsung Electronics Co., Ltd., Gyeonggi-do (KR)

(72) Inventors: Himke VAN DER VELDE, Middlesex (GB); Vinay Kumar SHRIVASTAVA, Bangalore (IN)

(21) Appl. No.: 18/551,682

(22) PCT Filed: Mar. 24, 2022
(86) PCT No.: PCT/KR2022/004141

§ 371 Date: Sep. 21, 2023

(30) Foreign Application Priority Data
Mar. 24, 2021 (IN) 202131012665
Mar. 23, 2022 (GB) 2204044.8

(51) Int. Cl. H04W 36/00; H04W 76/40

(52) U.S. Cl. CPC H04W 36/0007; H04W 76/40

(57) ABSTRACT

The disclosure relates to a 5G or 6G communication system for supporting a higher data transmission rate. Disclosed is a User Equipment, UE, operable with a telecommunication network, arranged to perform an operation associated with a Level 2, L2, entity involved with Multicast Broadcast Services, MBS, wherein the UE is arranged to perform the operation in response to one of: i) information received or acquired from the network or upon UE mobility; and ii) information provided in a message field received from the network, explicitly to trigger the UE to perform the operation.

### TECHNICAL FIELD

The invention relates to wireless communication, in general, and in particular, to the efficient and reliable reception of Multicast Broadcast Services (MBS) for New Radio (NR), a 5th generation Radio Access Technology (RAT).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

NR MBS services include:
Multicast services, for which the network transfers common user data that is intended to be received only by a specific group of UEs which have joined the concerned multicast group
Broadcast services, for which the network transfers common user data that can be received by all UEs interested to receive the service

The network may provide MBS services in a limited part of the network and coverage area of MBS services can be one cell or larger.

A 5G Core Network (CN) can deliver MBS user data to the Radio Access Network (RAN) using following delivery methods:
Individual delivery: for each individual UE receiving the MBS service, the CN delivers separate copies of the MBS user data packets to RAN (i.e. via per-UE PDU sessions, similar to unicast delivery)
Shared delivery: the CN delivers a single copy of MBS user data to RAN i.e. via a shared PDU session/tunnel), with the RAN handling delivery to one or multiple UEs

### DISCLOSURE OF INVENTION

### Technical Problem

In prior art E-UTRA specifications, rules were introduced defining in what cases the UE shall re-establish or reset the Layer 2, L2, entities (PDCP, RLC, Medium Access Control, MAC) e.g. upon cases like handover, change of Date Radio Bearer, DRB, type in case of Dual Connectivity, DC, and so on. In order to avoid the complexity associated with such rules, as well as to increase flexibility, in NR Radio Resource Control, RRC, a different approach was adopted whereby fields were introduced in dedicated RRC signalling, by which the network can indicate whether the UE shall perform concerned L2 operations.

In case of MBS, it is not clear yet in which cases certain L2 operations should be performed e.g. when to re-establish the common PDCP entity and what would trigger a UE to perform such actions. Moreover, there may be cases in which L2 operations are required while the UE is not in connected mode and hence the network cannot use dedicated signalling to invoke such actions. Also, a UE in connected mode may receive MBS based on broadcast/multi-cast signalling.

### Solution to Problem

It is an aim of embodiments of the present invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention, there is provided a User Equipment, UE, operable with a telecommunication network, arranged to perform an operation associated with a Level 2, L2, entity involved with Multicast Broadcast Services, MBS, wherein the UE is arranged to perform the operation in response to one of:
i) information received or acquired from the network or upon UE mobility; and
ii) information provided in a message field received from the network, explicitly to trigger the UE to perform the operation.

In an embodiment, in option i), the UE is in idle inactive or connected mode at the time of receiving or acquiring information or upon mobility.

In an embodiment, the operation is one of:
1a) Any change of the L2 configuration;
1b) Change of the L2 configuration involving certain specific L2 reconfigurations;
1c) Change of the L2 configuration involving change of SDAP configuration;
1d) Change of the L2 configuration involving change of PDCP configuration;
1e) Change of the L2 configuration involving change of RLC configuration;
If) Change of the L2 configuration involving re-establishment of an RLC bearer;
1g) Change of the L2 configuration involving change of MAC configuration including change of HARQ mode, change of G-RNTI, change of logical channel identity, LC ID, change of MBS BWP or Common Frequency Resource;
1h) Change of the L2 configuration involving MAC reset;
1i) Change of the L2 configuration involving RACH operation and/or add/release or suspend/resume of logical channel; and
1j) Change of the L2 configuration involving change of the MBSFN area.

In an embodiment, in option i), upon mobility or change of cell from which MBS is received, the L2 operation is performed as a result of one of:
2a) Any cell change;
2b) Any cell change that involves change of serving frequency
2c) Any cell change that involves change to a different Service Area, SA, as may be indicated by a different Service Area Identity, SAI; and
2d) Any cell change that involves change to a different MBSFN area.

In an embodiment, if the UE is in idle or inactive mode, the UE shall perform the L2 operation upon mobility or cell (re-)selection, including one of:
3a) Any cell re-selection;
3b) Any cell re-selection that involves change of serving frequency;
3c) Any idle or inactive UE mobility or cell re-selection that involves change to a different Service Area as may be indicated by a different Service Area Identity;

In an embodiment, the UE shall perform re-establishment or data recovery for a PDCP entity involved with MBS reception, or RLC re-establishment, or MAC reset, in response to at least one of the following:
4a) Upon receiving or acquiring related information from a broadcast or multicast control channel;
4b) Upon receiving related information by dedicated signalling;
4c) Upon UE mobility or change of cell.

In an embodiment, in option ii), the UE is in idle inactive or connected mode at the time of receiving or acquiring information or upon mobility.

In an embodiment, the signalling is provided by one of:
7a) the serving cell providing a field for each relevant neighbouring cell; and
7b) each relevant cell providing a field and the UE determining a need to perform L2 operations based on value applicable for source serving cell and target serving cell,

In an embodiment, the signalling is provided in of the following ways:
8a) Per individual MBS service;
8b) Commonly for a subset of the services that the network provides locally; and
8c) Commonly for all the services that the network provides locally.

In an embodiment, the signalling includes a field in which one of:
the UE can determine whether it shall perform re-establishment or data recovery for the PDCP entity involved with MBS reception;
the UE can determine whether it shall perform re-establishment for the RLC entity involved with MBS reception; and
the UE can determine whether it shall perform reset of the MAC entity involved with MBS reception.

According to a second aspect of the present invention, there is provided method of causing a User Equipment, UE, operable with a telecommunication network, to perform an operation associated with a Level 2, L2, entity involved with Multicast Broadcast Services, MBS, wherein the UE performs the operation in response to one of:
information received or acquired from the network or upon UE mobility; and
information provided in a message field received from the network, explicitly to trigger the UE to perform the operation.

### Advantageous Effects of Invention

By clarifying the Layer 2 operation of the UE receiving the MBS traffic, it is possible to properly provide a multicast broadcast service.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a schematic representation of entities involved in MBS according to the prior art;

FIG. 2 shows an example of a protocol stack for MBS in NR, according to the prior art;

FIG. 3 shows an example of control information received for MBS in NR according to the prior art; and

FIGS. 4 and 5 show flowcharts associated with first and second groups of embodiments of the present invention.

FIG. 6 illustrates the physical block diagram of the UE.

FIG. 7 illustrates the physical block diagram of the RAN.

### MODE FOR THE INVENTION

Hereinafter, various embodiments will be described in detail with reference to the accompanying drawings. It should be noted that in the accompanying drawings, the same or like elements are designated by the same or like reference numerals. Further, it should be noted that the following accompanying drawings of the disclosure are provided to help understanding of the disclosure and the disclosure is not limited to configurations or arrangements illustrated in the drawings of the disclosure. In addition, it should be noted that in the following description of the disclosure, only parts necessary for understanding operations according to various embodiments of the disclosure will be described and descriptions of the other parts will be omitted so as not to make the subject matter of the disclosure obscure.

Embodiments of the present invention primarily concern how to perform actions regarding L2 entities for RBs used for MBS, as introduced in NR Release-17, R17, covering UEs that are in idle, inactive and connected modes.

Embodiments of the invention provide for the Introduction of rules defining when a UE in Idle, Inactive or Connected mode shall perform certain L2 operations for the L2 entities involved with MBS reception e.g. re-establishment of PDCP, RLC or reset of MAC. Such embodiments define the required UE operations in a manner not involving additional signalling. In order to keep the rules relatively simple, the UE may perform such L2 operations when there is no particular need to do so. Such an approach has the advantage of less signalling being required, but may be less flexible and may result in a somewhat reduced performance.

Meanwhile, other embodiments of the invention provide for the introduction of signalling which defines when a UE in Idle, Inactive or Connected mode shall perform certain L2 operations for the L2 entities involved with MBS reception e.g. reestablishment of PDCP, RLC or reset of MAC. In such embodiments, the network has more control about when the UE performs L2 operations. In other words, the network can avoid such operations being performed when there is no real need. Therefore, these embodiments are more flexible and can result in somewhat improved performance, but at the cost of some additional signalling.

Although a few preferred embodiments of the present invention have been shown and described, it will be appreciated by those skilled in the art that various changes and modifications might be made without departing from the scope of the invention, as defined in the appended claims.

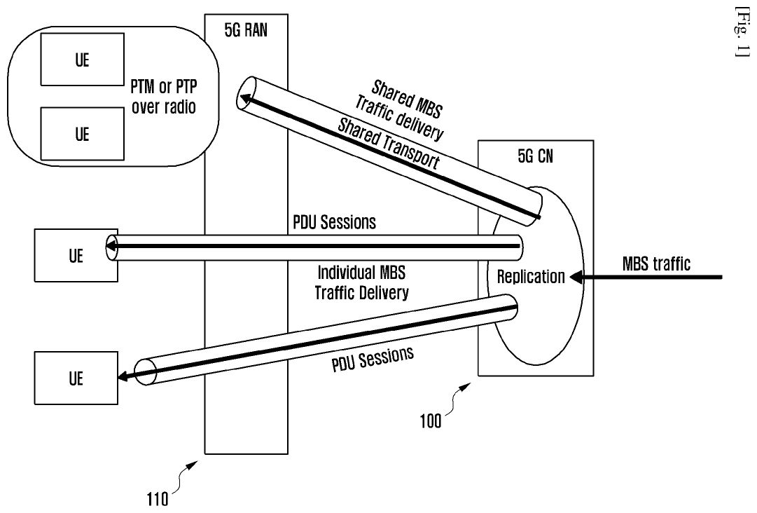

FIG. 1 shows a representation of this where MBS traffic is received at the CN 100, from where it is passed to one or more RANs 110. From there the MBS data is directed to UEs via one or several means:
From CN to RAN via shared MBS traffic delivery and then Point to Point (PTP) or Point to Multipoint (PTM) via a radio link.
From CN to UE via one or more PDU sessions

In case of shared delivery by the CN, the RAN delivers MBS data to UEs using either Point-to-Point delivery (PTP) or Point-to-Multipoint (PTM) delivery. Furthermore, at the UE, reception via an MBS radio bearer (MRB) can be supported using:
a single or common Service Data Adaptation Protocol, SDAP, entity
a single or common Packet Data Convergence Protocol, PDCP, entity
a single PTM Radio Link Control, RLC, bearer, a single PTP RLC bearer or a combination i.e. the UE is simultaneously configured with a PTM and a PTP RLC bearer (also referred to as PTM and PTP legs)

More specifically, a UE can be configured with:
a) A PTM RLC bearer only
b) A PTP RLC bearer only, either using RLC Unacknowledged Mode (UM, b.1) or RLC Acknowledged Mode (AM, b.2)
c) A split RLC bearer i.e. both a PTM and PTP RLC bearer, both using RLC UM
d) A split RLC bearer i.e. both a PTM and PTP RLC bearer, using RLC UM and RLC AM respectively

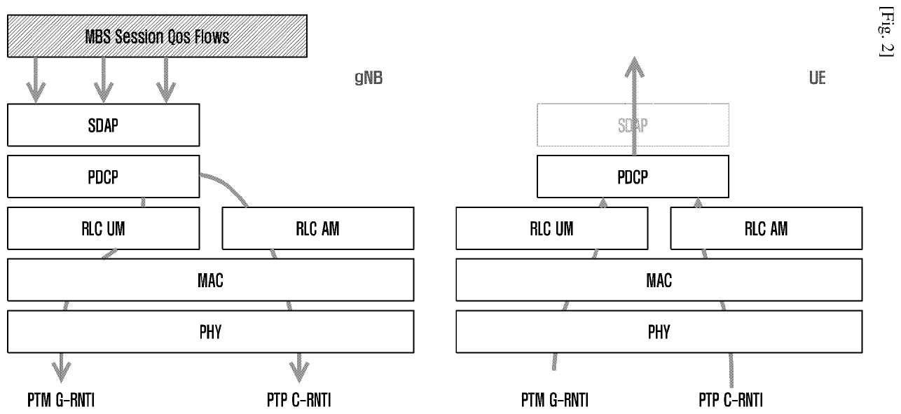

FIG. 2 shows an example of the protocol stack for MBS in an NR configuration. The MBS Session Quality of Service, QoS, flows are indicated by the arrows which traverse the figure on both the Base Station, gNB, and UE parts. The various entities shown have been preciously described.

In some cases, the configuration used by the UE changes from one mode to another i.e. different configuration changes or switches can be supported e.g. between a) and b.1), in which case the UE may use c) in-between. It should be noted that certain restrictions may apply for the reconfiguration/switch between b.1 and b.2, as specified in prior art standards.

Discussions are ongoing regarding whether there is a need to use different security for the PTM and PTP RLC bearers/legs. If required, PDCP may need to include separate security context for each of the RLC bearers/legs. The other PDCP context (configuration and status) can still be common for the two legs. So far, PDCP is reestablished when security is changed e.g. key change. In case there are separate security contexts for each of the RLC bearers/legs, the same approach is appropriate i.e. in such a case, for PDCP re-establishment, the following options are possible:
1) PDCP re-establishment, including re-set of the security context for both RLC bearers
2) PDCP re-establishment, including re-set of the security context for one of the RLC bearers

In prior art E-UTRA specifications, rules were introduced defining in what cases the UE shall re-establish or reset the Layer 2, L2, entities (PDCP, RLC, Medium Access Control, MAC) e.g. upon cases like handover, change of Date Radio Bearer, DRB, type in case of Dual Connectivity, DC, and so on. In order to avoid the complexity associated with such rules, as well as to increase flexibility, in NR Radio Resource Control, RRC, a different approach was adopted whereby fields were introduced in dedicated RRC signalling, by which the network can indicate whether the UE shall perform concerned L2 operations.

In case of MBS, it is not clear yet in which cases certain L2 operations should be performed e.g. when to re-establish the common PDCP entity and what would trigger a UE to perform such actions. Moreover, there may be cases in which L2 operations are required while the UE is not in connected mode and hence the network cannot use dedicated signalling to invoke such actions. Also, a UE in connected mode may receive MBS based on broadcast/multi-cast signalling.

There may be cases in which a UE that is in idle, inactive or connected mode needs to perform certain operations for the L2 entities involved with MBS reception e.g. PDCP reconfiguration/re-establishment. This can include the following cases (others not excluded):
1) Change of PDCP Service Data Unit, SDU, to PDCP Sequence Number, SN, mapping, including UE mobility for which PDCP SN synchronisation/continuation does not apply
2) Change of PTM RLC bearer config, regardless of whether upon UE mobility or upon network reconfiguration
3) Change of Multimedia Broadcast multicast service Single Frequency Network, MBSFN, area, regardless of whether upon UE mobility or upon network reconfiguration

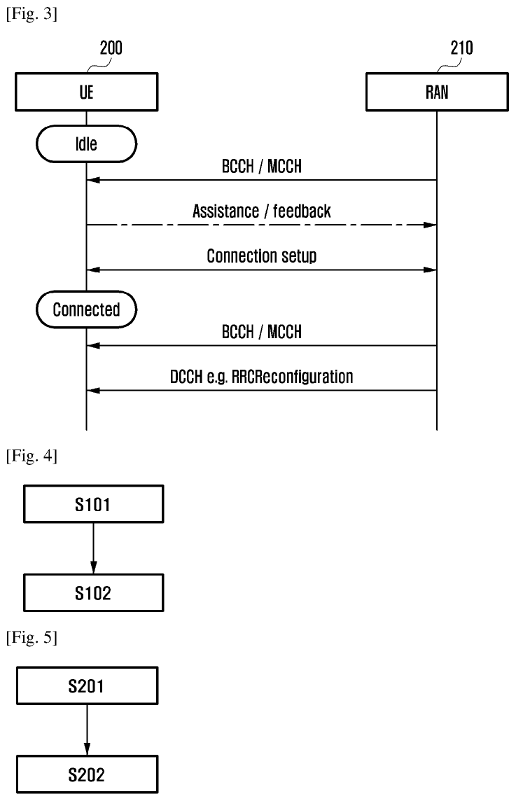

FIG. 3 shows an example of control information received for MBS in NR.

It shows a UE 200 and an associated RAN 210 and certain messages exchanged therebetween with the UE initially in Idle mode and then connected mode.

The following embodiments relate, generally, to means of invoking L2 operations.

In the following embodiments, it is necessary to specify in which cases a UE in idle, inactive or connected mode shall perform certain operations for L2 entities involved with MBS reception, including L2 entities involved with user data received via PTM leg/PTM RLC bearer.

More specifically, a first group of embodiments relate to invoking L2 operations, not involving introduction of specific indications. Such embodiments concern solutions in which the UE determines a need to perform L2 actions based on information received or acquired and/or upon UE mobility (e.g, handover). The solutions referred to herein in relation to this embodiment do not involve the introduction of fields specifically for the purpose of triggering certain L2 actions e.g. a field explicitly indicating that UE shall initiate PDCP re-establishment. In other words, no explicit instruction is provided to the UE and so it takes action on the basis of some other indication, as will be set out in the following. There are several different triggers which may be used and these are described in the following.

In one embodiment, rules are introduced in the standard specification defining in which cases a UE in idle, inactive or connected mode shall perform certain operations for L2 entities involved with MBS reception

In particular, a rule is introduced in the standard specification, defining that a UE shall perform L2 actions upon receiving or acquiring related information from a broadcast or multicast control channel, possibly involving UE mobility, including at least one of the following options:
1a) Any change of the L2 configuration
1b) Change of the L2 configuration involving certain specific L2 reconfigurations
1c) Change of the L2 configuration involving change of SDAP configuration e.g. change in QoS flow to MRB mapping, changes of the sub-streams UE receives for a service (e.g. just lower QoS part of video stream)
1d) Change of the L2 configuration involving change of PDCP configuration e.g. change of security configuration, change of Robust Header Compression, ROHC, configuration
1e) Change of the L2 configuration involving change of RLC configuration e.g. addition, release, suspension of resumption of an RLC bearer or change of SN size for an RLC bearer or change of RLC mode for an RLC bearer (e.g. between UM and AM)
1f) Change of the L2 configuration involving re-establishment of an RLC bearer
1g) Change of the L2 configuration involving change of MAC configuration including change of HARQ mode (e.g. no feedback based Hybrid Automatic Repeat Request, HARQ, retransmission, no HARQ etc.), change of G-RNTI, change of logical channel identity (LC ID), change of MBS BWP or Common Frequency Resource
1h) Change of the L2 configuration involving MAC reset
1i) Change of the L2 configuration involving RACH operation and/or add/release or suspend/resume of logical channel
1j) Change of the L2 configuration involving change of the MBSFN area

In a further embodiment, a rule is introduced in the standard specification, defining that a UE shall perform L2 actions upon receiving related information by dedicated signalling, possibly involving UE mobility, including, for instance, features 1a) to 1j) above.

In a further embodiment, a rule is introduced in the standard specification, defining that a UE shall perform L2 actions upon mobility or change of the cell from which MBS is received, including at least one of the following:
2a) Any cell change
2b) Any cell change that involves change of serving frequency (inter-frequency change)
2c) Any cell change that involves change to a different Service Area, SA, as may be indicated by a different Service Area Identity, SAI
2d) Any cell change that involves change to a different MBSFN area

In a further embodiment, a rule is introduced in the standard specification, defining that a UE in idle or inactive mode shall perform L2 actions upon mobility or cell (re-)selection, including at least one of the following:
3a) Any cell re-selection
3b) Any cell re-selection that involves change of serving frequency (inter-frequency re-selection)
3c) Any idle or inactive UE mobility or cell re-selection that involves change to a different Service Area as may be indicated by a different Service Area Identity

In a further embodiment, a rule is introduced in the standard specification, defining that a UE shall perform re-establishment or data recovery for the PDCP entity involved with MBS reception, including at least one of the following:
4a) Upon receiving or acquiring related information from a broadcast or multicast control channel as described above, including all possible options in features 1a) to 1j)
4b) Upon receiving related information by dedicated signalling as described above
4c) Upon UE mobility or change of cell as described above, including all options 2a) to 2d) and 3a) to 3c)

In a further embodiment, a rule is introduced in the standard specification, similar to the above, defining when a UE shall perform RLC re-establishment, including at least one of the following:
5a) Upon receiving or acquiring related information from a broadcast or multicast control channel as described above, including all possible options listed in 1a) to 1j)
5b) Upon receiving related information by dedicated signalling as described above, including all possible options listed
5c) Upon UE mobility or change of cell as described above including all options 2a) to 2d) and 3a) to 3c)

In a further embodiment, a rule is introduced in the standard specification, similar to the above, defining when a UE shall perform MAC reset, including at least one of the following:
6a) Upon receiving or acquiring related information from a broadcast or multicast control channel as described above, including all possible options listed in 1a) to 1j)
6b) Upon receiving related information by dedicated signalling as described above, including all possible options listed
6c) Upon UE mobility or change of cell as described above including all options 2a) to 2d) and 3a) to 3c)

A second group of embodiments of the invention relate to invoking L2 operations, by the introduction of specific fields or indications. In other words, explicit instructions are provided, unlike in the previous embodiments, where implicit triggers are defined and used.

In the following, embodiments are presented in which the UE determines a need to perform L2 actions, based on fields that are introduced specifically for the purpose of triggering certain L2 actions e.g. a field explicitly indicating that UE shall initiate PDCP re-establishment.

In an embodiment, broadcast or multicast control signalling is introduced, based on which, a UE in idle, inactive or connected mode can determine whether it shall perform certain operations for L2 entities involved with MBS reception, i.e. fields are introduced specifically for the purpose of triggering certain L2 actions, including relating to L2 entities involved with user data received via PTM leg or PTM RLC bearer.

In an embodiment, options for providing the broadcast or multicast control signalling includes at least the following:
7a) the serving cell providing a field for each (relevant i.e. involved with MBS) neighbouring cell
7b) each relevant cell providing a field and the UE determining a need to perform L2 operations based on value applicable for source serving cell and target serving cell

In a further embodiment, the field in broadcast or multicast control signalling can be provided in different ways, including one or more of:
8a) Per individual MBS service
8b) Common for a subset of the services that network provides locally
8c) Common for all the services that network provides locally

In a further embodiment, a field is introduced in broadcast or multicast control signalling based on which a UE can determine whether it shall perform reestablishment or data recovery for the PDCP entity involved with MBS reception.

An example, based on option 7b) above, is that each cell indicates one or more fields representing the PDCP state. If the UE determines that source and target cell signal a different value for (one of) the field(s), then the UE performs PDCP re-establishment. One possible realisation of a field indicating PDCP state is a PDCP SN synchronisation area identity.

The further details regarding the actions that the UE performs upon cases described in this application (e.g. PDCP re-establishment) may be as specified in prior art standard specifications, although deviations are not excluded. For example, UE actions upon PDCP data recovery may involve initiating a PDCP status report.

In a further embodiment, a field is introduced in broadcast or multicast control signalling based on which a UE can determine whether it shall perform reestablishment for the RLC entity involved with MBS reception.

An example, based on previous option 7b) above, each cell indicates one or more fields representing the RLC state e.g. a number or toggle. If the UE determines that the source and target cell signal a different value for (one of) the field(s), the UE performs RLC re-establishment.

In a further embodiment, a field is introduced in broadcast or multicast control signalling, based on which a UE can determine whether it shall perform reset of the MAC entity involved with MBS reception.

An example, based on the previous option 7b), is that each cell indicates one or more fields representing the MAC state e.g. a number or toggle. If UE determines that source and target cell signal a different value for (one of) the field(s), the UE performs MAC reset. One possible example of a field which may be used for indicating MAC state is an MBSFN area identity.

In a third embodiment, a field is introduced in dedicated signalling based on which a UE can determine whether it shall perform certain operations for L2 entities involved with MBS reception, including L2 entities involved with user data received via PTM leg/PTM RLC bearer, as described the previous embodiments which operate by the introduction of specific fields or indications, including all possible options or examples presented herein.

In a further group of embodiments, the UE is able to initiate other actions based on broadcast, multicast or dedicated signalling.

In a first embodiment, it is specified in which cases a UE in idle or, inactive or connected mode shall perform certain operations for MBS, either by rules based on broadcast, multicast or dedicated signalling, or based on fields in broadcast, multicast or dedicated control signalling, introduced to enable the network to specifically request such UE actions, including the following UE actions:
9a) Initiate connection establishment, for instance to receive an MBS service that the network only provides by PTP, which the UE can only receive by PTP or by PTM in connected, or to provide MBS related assistance to the network
9b) Initiate RA or some other L2 procedure merely to provide MBS related assistance to the network

Further, the specification may reflect how the UE triggers these actions, including the following options:
9c) Introduce a rule in the standard specification defining that a UE shall perform these actions based on information received or acquired, and/or upon UE mobility
9d) Introduce broadcast or multicast control or dedicated signalling, based upon which, the UE can determine whether it shall perform these actions

Further, the standard specification may introduce means by which the UE can provide further assistance while performing the actions as indicated above, where it is specified in which cases a UE in idle or, inactive or connected mode shall perform certain operations for MBS, either by rules based on broadcast, multicast or dedicated signalling, or based on fields in broadcast, multicast or dedicated control signalling, introduced to enable the network to specifically request such UE actions. For instance, such means may include:
10a) Indicate that the UE initiates connection establishment for the purpose of MBS, and possibly provide further details e.g. whether this is to provide certain assistance (e.g. MBS interest), to receive MBS service in connected mode etc.
10b) Indicate that the UE initiates RA for the purpose of MBS, and possibly provide further details e.g. to indicate interest to receive a MBS session

FIG. 4 shows a flow chart relating to the first group of embodiments.

At step S101, the UE determines the need to perform an L2 action on the basis of information received or acquired and/or upon UE mobility.

At step S102, the UE takes the action determined at step S101.

FIG. 5 shows a flow chart relating to the second group of embodiments.

At step S201, the UE determines the need to perform an L2 action on the basis of one or more fields that are introduced specifically for the purpose of triggering certain L2 actions.

At step S202, the UE takes the action determined at Step S201.

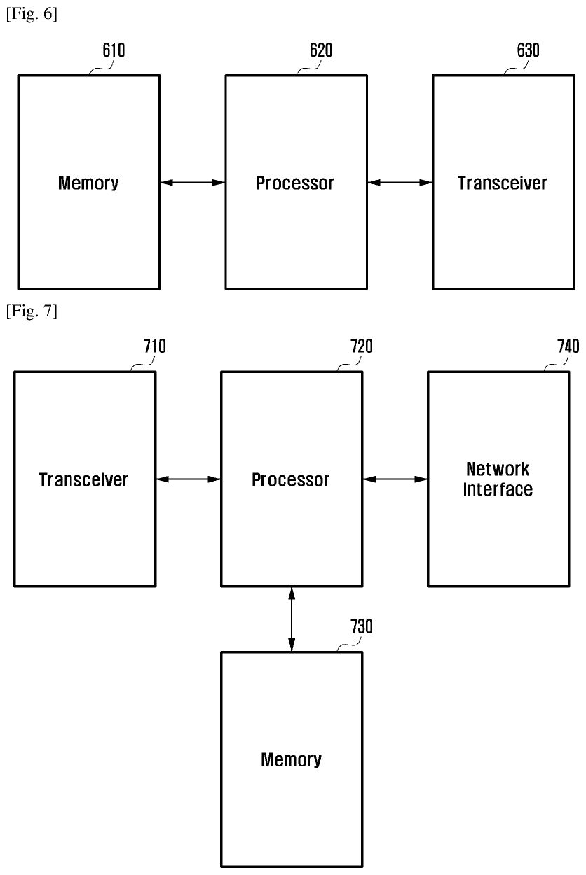

FIG. 6 illustrates the physical block diagram of the UE.

Referring to FIG. 6, the UE may include a memory 610, a processor 620, and a transceiver 630. The UE according to the present invention may further have other components. For example, the UE may include a user input unit, a display unit, a speaker, at least one sensor, and the like. The present invention does not limit the additional components of the UE.

The memory 610 may store information for the MBS described above.

The processor 620 may control the operation according to the embodiment proposed in this specification. For example, the processor 620 may control according to the operations described with reference to FIG. 4 and FIG. 5. In addition, the processor 620 may perform an operation for receiving the MBS based on the control information according to the present disclosure.

The transceiver 630 may transmit and receive signals to and from the 5G RAN. Further, the transceiver 630 may have components for transmitting and receiving a signal to and from the 5G RAN. The components may include, for example, an antenna, a radio circuit, a mixer, an amplifier, and the like.

The components of the UE described above have been described as physical components. However, the components of FIG. 6 may be mapped to a hierarchical form as in FIG. 2 described above. Since this is well known to those skilled in the art, it will not be further described.

FIG. 7 illustrates the physical block diagram of the RAN.

Referring to FIG. 7, the RAN may include a memory 730, a processor 720, a network interface 740 and a transceiver 710. The RAN according to the present invention may further have other components. The present invention does not limit the additional components of the RAN.

The memory 730 may store information for the MBS described above.

The processor 720 may control the operation according to the embodiment proposed in this specification. For example, the processor 720 may control according to the operations described with reference to FIG. 4 and FIG. 5. In addition, the processor 720 may perform an operation for transmitting the MBS based on the control information according to the present disclosure.

The transceiver 710 may transmit and receive signals to and from the UE. In addition, the transceiver 710 may have components for transmitting and receiving a signal to and from the UE. The components may include, for example, an antenna, a radio circuit, a mixer, an amplifier, and the like.

The network interface 740 may communicate with a specific network function of the 5G CN 100. For example, the network interface 740 may communicate with an access and mobility management function (AMF) for managing the mobility of the UE, and may communicate with a user plane function (UPF) that transmits MBS traffic.

The components of the RAN described above have been described as physical components. However, the components of FIG. 7 may be mapped to a hierarchical form as in FIG. 2 described above. Since this is well known to those skilled in the art, it will not be further described.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

### INDUSTRIAL APPLICABILITY

The present invention can be applied to the case of providing MBS to an electronic device, for example, a UE.

1-11. (canceled)

12. A method performed by a terminal in a wireless communication system, the method comprising:
obtaining multicast broadcast service (MBS) configuration information;
identifying whether to modify a configuration of an MBS radio bearer (MRB); and
in case that the terminal decides to modify the configuration of the MRB, configuring a layer 2 based on the MBS configuration information.

13. The method of claim 12, wherein configuring the layer 2 comprises:
in case that the MBS configuration information is broadcast MRB configuration information obtained via a multicast control channel (MCCH), establishing at least one of a packet data convergence protocol (PDCP) layer, a media access control (MAC), or a radio link control (RLC) layer, based on the broadcast MRB configuration information.

14. The method of claim 13, wherein the broadcast MRB configuration information includes information on a list of neighboring cells associated with ongoing MBS sessions.

15. The method of claim 13, wherein the terminal is in at least one of an idle mode, an inactive mode, or a connected mode.

16. The method of claim 12, wherein configuring the layer 2 comprises:
in case that the MBS configuration information is configuration information associated with a multicast MRB obtained via a radio resource control (RRC) message, reestablishing a packet data convergence protocol (PDCP) layer, based on the configuration information associated with the multicast MRB.

17. The method of claim 16, wherein the configuration information associated with the multicast MRB includes an indication to reestablish the PDCP layer.

18. A method performed by a base station in a wireless communication system, the method comprising:
generating multicast broadcast service (MBS) configuration information; and
transmitting, to a terminal, the MBS configuration information,
wherein a layer 2 is configured based on the MBS configuration information.

19. The method of claim 18, wherein in case that the MBS configuration information is broadcast MRB configuration information transmitted via a multicast control channel (MCCH), at least one of a packet data convergence protocol (PDCP) layer, a media access control (MAC), or a radio link control (RLC) layer is established based on the broadcast MRB configuration information.

20. The method of claim 19, wherein the broadcast MRB configuration information includes information on a list of neighboring cells associated with ongoing MBS sessions, and
wherein the terminal is in at least one of an idle mode, an inactive mode, or a connected mode.

21. The method of claim 18, wherein in case that the MBS configuration information is configuration information associated with a multicast MRB transmitted via a radio resource control (RRC) message, a packet data convergence protocol (PDCP) layer is reestablished based on the configuration information associated with the multicast MRB, and
wherein the configuration information associated with the multicast MRB includes an indication to reestablish the PDCP layer.

22. A terminal in a wireless communication system, the terminal comprising:
a transceiver; and
a controller configured to
obtain multicast broadcast service (MBS) configuration information,
identify whether to modify a configuration of an MBS radio bearer (MRB), and
in case that the terminal decides to modify the configuration of the MRB, configure a layer 2 based on the MBS configuration information.

23. The terminal of claim 22, wherein the controller is further configured to, in case that the MBS configuration information is broadcast MRB configuration information obtained via a multicast control channel (MCCH), establish at least one of a packet data convergence protocol (PDCP) layer, a media access control (MAC), or a radio link control (RLC) layer, based on the broadcast MRB configuration information.

24. The terminal of claim 23, wherein the broadcast MRB configuration information includes information on a list of neighboring cells associated with ongoing MBS sessions.

25. The terminal of claim 23, wherein the terminal is in at least one of an idle mode, an inactive mode, or a connected mode.

26. The terminal of claim 22, wherein the controller is further configured to, in case that the MBS configuration information is configuration information associated with a multicast MRB obtained via a radio resource control (RRC) message, reestablishing a packet data convergence protocol (PDCP) layer, based on the configuration information associated with the multicast MRB.

27. The terminal of claim 26, wherein the configuration information associated with the multicast MRB includes an indication to reestablish the PDCP layer.

28. A base station in a wireless communication system, the base station comprising:
a transceiver; and
a controller configured to;
generate multicast broadcast service (MBS) configuration information, and
transmit, to a terminal, the MBS configuration information,
wherein a layer 2 is configured based on the MBS configuration information.

29. The base station of claim 28, wherein, in case that the MBS configuration information is broadcast MRB configuration information transmitted via a multicast control channel (MCCH), at least one of a packet data convergence protocol (PDCP) layer, a media access control (MAC), or a radio link control (RLC) layer is established based on the broadcast MRB configuration information.

30. The base station of claim 29, wherein the broadcast MRB configuration information includes information on a list of neighboring cells associated with ongoing MBS sessions, and
wherein the terminal is in at least one of an idle mode, an inactive mode, or a connected mode.

31. The base station of claim 28, wherein, in case that the MBS configuration information is configuration information associated with a multicast MRB transmitted via a radio resource control (RRC) message, a packet data convergence protocol (PDCP) layer is reestablished based on the configuration information associated with the multicast MRB, and
wherein the configuration information associated with the multicast MRB includes an indication to reestablish the PDCP layer.
